(19) United States
(12) Patent Application Publication
(10) Pub. No.: US 2024/0294797 A1
(43) Pub. Date: Sep. 5, 2024

(54) Coating Compositions and Coatings Obtainable Therefrom Having Improved Soiling Resistances and (Self-) Cleaning Properties

(71) Applicant: Kavestro Deutschland AG, Leverkusen (DE)

(72) Inventors: Yvonne Reimann, Frechen (DE); Tanja Hebestreit, Wipperfürth (DE); Jan Weikard, Leverkusen (DE); Hans-Josef Laas, Odenthal (DE)

(21) Appl. No.: 18/572,294

(22) PCT Filed: Jun. 20, 2022
(86) PCT No.: PCT/EP2022/066712

§ 371 Date: Dec. 20, 2023

(30) Foreign Application Priority Data
Jun. 21, 2021 (EP) 21180672.4

(51) Int. Cl. C09D 175/04; C08G 18/80

(52) U.S. Cl. CPC C09D 175/04; C08G 18/809

(57) ABSTRACT

The invention relates to nonaqueous coating compositions containing at least one thioallophanate with free or blocked isocyanate groups and with silane groups, at least one isocyanate-reactive compound, at least one catalyst for the crosslinking of the silane groups and at least one alkoxysilyl-functional and/or hydroxyl group-containing siloxane, to the use of these coating compositions for producing coatings and paint systems, more particularly for use in the transport sector, i.e. in vehicles, especially in ships, aircraft, motor vehicles such as cars, trucks, buses, large vehicles, rail vehicles, etc. The coating compositions are suitable in particular for producing clearcoats.

### CROSS-REFERENCE TO RELATED APPLICATIONS

This application is the United States national phase of International Application No. PCT/EP2022/066712 filed Jun. 20, 2022, and claims priority to European Patent Application No. 21180672.4 filed Jun. 21, 2021, the disclosures of which are hereby incorporated by reference in their entireties.

### BACKGROUND

### Technical Field

The invention relates to nonaqueous coating compositions containing at least one thioallophanate with free or blocked isocyanate groups and with silane groups, at least one isocyanate-reactive compound, at least one catalyst for the crosslinking of the silane groups and at least one alkoxysilyl-functional and/or hydroxyl group-containing siloxane, to the use of these coating compositions for producing coatings and paint systems, more particularly for use in the transport sector, i.e. in vehicles, especially in ships, aircraft, motor vehicles such as cars, trucks, buses, large vehicles, rail vehicles, etc. The coating compositions are suitable in particular for producing clearcoats.

### Description of Related Art

The use of two-component polyurethane (2K PUR) clearcoats has over the last three decades become established in the automotive OEM finishing sector. WO2017/042177 discloses 2K PUR coating materials based on silane group-containing thioallophanates as crosslinking agents, which cure to give highly scratch-resistant coats and find use in particular in the automotive finishing sector, preferably as clearcoats.

An object of the present invention was to provide novel coating compositions which cure to give highly scratch-resistant and solvent-resistant coatings, where these coatings should additionally feature very good soiling resistances and (self-)cleaning properties. Moreover, the coating compositions should satisfy the requirements typically placed on the clearcoat layer in paint systems in the transport sector, such as automotive OEM finishings and automotive refinishings.

This object was achieved by the provision of the following coating composition according to the invention, which is described in more detail hereinafter and, in addition to at least one silane group-containing, NCO-functional thioallophanate, contains at least one specific alkoxysilyl-functional and/or one specific hydroxyl group-containing siloxane.

WO2017/202692 discloses coating compositions and coatings obtainable therefrom with improved soiling resistances and (self-)cleaning properties, which are obtainable using aminosilane-functionalized isocyanates in combination with alkoxysilyl-functional siloxanes. The use of silane group- and isocyanate group-containing thioallophanates in combination with alkoxysilyl-functional and/or hydroxyl group-containing siloxanes is not mentioned or suggested.

### SUMMARY

The present invention provides nonaqueous coating compositions containing or consisting of
A) at least one polyisocyanate component (A) which contains at least one silane group-containing thioallophanate of the general formula (I),

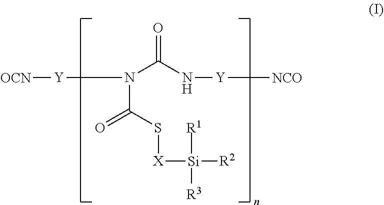

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical having at least 2 carbon atoms,
Y is a linear or branched, aliphatic or cycloaliphatic, an araliphatic or aromatic radical having up to 18 carbon atoms and
n is an integer from 1 to 20,
B) at least one isocyanate-reactive compound (B), excluding compounds of component Cii),
C) i) at least one alkoxysilyl-functional siloxane (Ci) of formula (II)

R⁴—SiR⁵₂-Aₓ-B_{y}—O—SiR⁶₂-R⁷ (II),
in which A is an —[O—SiR⁸₂]— group and B is an —[O—SiR⁹R¹⁰]— group,
R⁵, R⁶, R⁸ and R⁹ independently of one another are linear or branched alkyl groups having 1 to 4 carbon atoms,
R⁴, R⁷ and R¹⁰ independently of one another are an -L-R¹¹ group, in which
L=a linear or branched 2-valent alkyl group and
R¹¹═H or —Si(R¹²)_{z}(OR¹³)_{3-z} where R¹², R¹³=a linear or branched alkyl group having 1 to 4 carbon atoms and z=0, 1 or 2, preferably z=0,
with the proviso that at least one of the radicals R⁴ or R⁷ and/or at least one group B includes a group R¹¹═—Si(R¹²)_{z}(OR¹³)_{3-z},
x is independently an integer from 1-20 and
y is independently an integer from 0-10,
wherein preferably x+y≤20,
and/or
ii) at least one hydroxyl group-containing siloxane (Cii) of formula (III)

R¹⁴—SiR¹⁵₂—(O—SiR¹⁶₂)_{w}—O—SiR¹⁷₂-R¹⁸ (11)
in which
R¹⁵, R¹⁶ and R¹⁷ independently of one another are linear or branched alkyl groups having 1 to 4 carbon atoms,
R¹⁴ and R¹⁸ independently of one another are an -L′-R¹⁹ group, in which
L′=a linear or branched 2-valent alkyl group and R¹⁹═H or OH, with the proviso that at least one of the radicals R¹⁴ or R¹⁸ corresponds to a radical -L′-OH,
w is an integer from 1-20,
D) at least one catalyst for the crosslinking of silane groups (D), and
E) optionally further auxiliaries and additives (E).

The invention also provides for the use of these nonaqueous coating compositions for producing polyurethane coats, more particularly for use in the transport sector, i.e. for finishing vehicles, especially ships, aircraft, motor vehicles such as cars, trucks, buses, large vehicles, rail vehicles. The coats are in particular clearcoats.

The coating composition according to the invention is nonaqueous. This means that, in the context of the present invention, the coating compositions contain organic solvents or are formulated as anhydrous systems. In any case, the coating composition contains only minor amounts of water, and preferably no water (anhydrous). Particularly preferably, less than 5% by weight of water, preferably less than 2.5% by weight of water, is present based on the total weight of the coating composition.

### DETAILED DESCRIPTION

### Component (A)

The polyisocyanate component (A) of the coating compositions according to the invention contains at least one silane group-containing thioallophanate of the general formula (I)

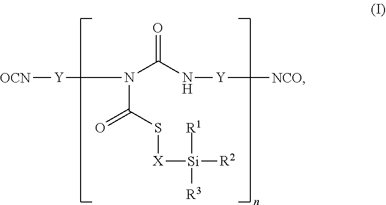

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical having at least 2 carbon atoms,
Y is a linear or branched, aliphatic or cycloaliphatic, an araliphatic or aromatic radical having up to 18 carbon atoms and
n is an integer from 1 to 20.

In a preferred embodiment of the present invention, the polyisocyanate component (A) of the coating compositions according to the invention consists of at least one silane group-containing thioallophanate of the general formula (I).

These silane group-containing thioallophanates are prepared by reacting
a) at least one monomeric diisocyanate of the general formula (IV)

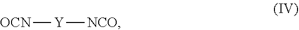

in which Y is a linear or branched, aliphatic or cycloaliphatic, an araliphatic or aromatic radical having up to 18 carbon atoms, with
b) mercaptosilanes of the general formula (V)

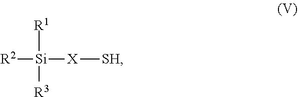

in which
R¹, R², R³ and X are as defined above,
in an equivalents ratio of isocyanate groups to mercapto groups of 2:1 to 40:1.

Suitable starting compounds a) for preparing the silane group-containing thioallophanates are any desired diisocyanates having aliphatically, cycloaliphatically, araliphatically and/or aromatically bonded isocyanate groups, which may be prepared by any desired processes, for example by phosgenation or by a phosgene-free route, for example by means of urethane cleavage.

Suitable diisocyanates are, for example, those of the general formula (IV)

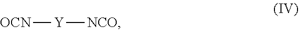

in which Y is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 5 to 18 carbon atoms, such as for example 1,4-diisocyanatobutane, 1,5-diisocyanatopentane (PDI), 1,6-diisocyanatohexane (HDI), 1,5-diisocyanato-2,2-dimethylpentane, 2,2,4or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene, 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate and any desired mixtures of these isomers, diphenylmethane 2,4′- and/or 4,4′-diisocyanate and naphthylene 1,5-diisocyanate and any desired mixtures of such diisocyanates. Further diisocyanates which are likewise suitable can be found, furthermore, for example, in Justus Liebigs Annalen der Chemie Volume 562 (1949) pp. 75-136.

Particularly preferred as starting component a) are diisocyanates of the general formula (IV) in which Y is a linear or branched, aliphatic or cycloaliphatic radical having 5 to 13 carbon atoms.

Very particularly preferred starting components a) for the process according to the invention are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

The starting components b) for preparing the silane group-containing thioallophanates are any desired mercaptosilanes of the general formula (V)

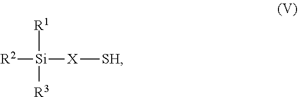

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen, and
X is a linear or branched organic radical having at least 2 carbon atoms.

Examples of suitable mercaptosilanes b) are 2-mercaptoethyltrimethylsilane, 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropyltriethoxysilane, 3-mercaptopropylethyldimethoxysilane, 3-mercaptopropylethyldiethoxysilane and/or 4-mercaptobutyltrimethoxysilane.

Preferred mercaptosilanes b) for preparing the silane group-containing thioallophanates are those of the general formula (V) in which
R¹, R² and R³ are identical or different radicals and are each a saturated, linear or branched, aliphatic or cycloaliphatic radical having up to 6 carbon atoms, which may optionally contain up to 3 oxygen atoms, and
X is a linear or branched alkylene radical having 2 to 10 carbon atoms.

Particularly preferred mercaptosilanes b) are those of the general formula (V) in which
R¹, R² and R³ are each alkyl radicals having up to 6 carbon atoms and/or alkoxy radicals which contain up to 3 oxygen atoms, with the proviso that at least one of the radicals R¹, R² and R³ is such an alkoxy radical, and
X is a propylene radical (—CH₂—CH₂—CH₂—).

Very particularly preferred mercaptosilanes b) are those of the general formula (V) in which
R¹, R² and R³ are identical or different radicals and are each methyl, methoxy or ethoxy, with the proviso that at least one of the radicals R¹, R² and R³ is a methoxy or ethoxy radical, and
X is a propylene radical (—CH₂—CH₂—CH₂—).

For preparing the silane group-containing thioallophanates, the diisocyanates a) are reacted with the mercaptosilanes b) at temperatures from 20 to 200° C., preferably 40 to 160° C., observing an equivalents ratio of isocyanate groups to mercapto groups of 2:1 to 40:1, preferably of 4:1 to 30:1, particularly preferably 6:1 to 20:1, to give thioallophanates.

The reaction can be carried out uncatalyzed, as a thermally induced allophanatization. Preferably, however, suitable catalysts are used for accelerating the allophanatization reaction. These are the customary known allophanatization catalysts, examples being metal carboxylates, metal chelates or tertiary amines of the type described in GB-A0 994 890, or alkylating agents of the type described in US-A3 769 318, or strong acids as described by way of example in EP-A0 000 194.

Suitable allophanatization catalysts are in particular zinc compounds, such as zinc(II) stearate, zinc(II) n-octanoate, zinc(II) 2-ethyl-1-hexanoate, zinc(II) naphthenate or zinc(II) acetylacetonate, tin compounds, such as tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate or dioctyltin diacetate, zirconium compounds, such as zirconium(IV) 2-ethyl-1-hexanoate, zirconium(IV) neodecanoate, zirconium(IV) naphthenate or zirconium(IV) acetylacetonate, aluminum tri(ethylacetoacetate), iron(III) chloride, potassium octoate, manganese, cobalt or nickel compounds, and also strong acids, such as trifluoroacetic acid, sulfuric acid, hydrogen chloride, hydrogen bromide, phosphoric acid or perchloric acid, for example, or any desired mixtures of these catalysts.

Also suitable, albeit less preferred, catalysts for preparing the silane group-containing thioallophanates are compounds which in addition to the allophanatization reaction also catalyze the trimerization of isocyanate groups to form isocyanurate structures. Catalysts of this kind are described for example in EP-A0 649 866 on page 4, line 7 to page 5, line 15.

Preferred catalysts for preparing the silane group-containing thioallophanates are zinc and/or zirconium compounds of the aforementioned kind. Very particularly preferred is the use of zinc(II) n-octanoate, zinc(II) 2-ethyl-1-hexanoate and/or zinc(II) stearate, zirconium(IV) n-octanoate, zirconium(IV) 2-ethyl-1-hexanoate and/or zirconium(IV) neodecanoate.

In the preparation of the silane group-containing thioallophanates, these catalysts are employed, if at all, in an amount of 0.001% to 5% by weight, preferably 0.005% to 1% by weight, based on the total weight of the reactants a) and b), and may be added either before the beginning of the reaction or at any point during the reaction.

The preparation of the silane group-containing thioallophanates is preferably carried out without solvent. Optionally, however, it is also possible to use suitable solvents which are inert with respect to the reactive groups of the starting components. Suitable solvents are, for example, the customary coatings solvents that are known per se such as ethyl acetate, butyl acetate, ethylene glycol monomethyl or monoethyl ether acetate, 1-methoxy-2-propyl acetate (MPA), 3-methoxy-n-butyl acetate, acetone, 2-butanone, 4-methyl-2-pentanone, cyclohexanone, toluene, xylene, chlorobenzene, white spirit, relatively highly substituted aromatics, of the kind available commercially, for example, under the names solvent naphtha, Solvesso®, Isopar®, Nappar®, Varsol® (ExxonMobil Chemical Central Europe, Cologne, DE) and Shellsol® (Shell Deutschland Oil GmbH, Hamburg, DE), and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents. These solvents or solvent mixtures preferably include a water content of at most 1.0% by weight, particularly preferably at most 0.5% by weight, based on solvent used.

In one possible embodiment, during the preparation of the silane group-containing thioallophanates, the starting diisocyanate a) or a mixture of various starting diisocyanates a) is introduced optionally under inert gas, such as nitrogen, for example, and optionally in the presence of a suitable solvent of the stated kind, at a temperature between 20 and 100° C. Subsequently, the mercaptosilane b) or a mixture of various mercaptosilanes is added in the amount stated above, and the reaction temperature for the thiourethanization is adjusted optionally by an appropriate measure (heating or cooling) to a temperature of 30 to 120° C., preferably of 50 to 100° C. Following the thiourethanization reaction, i.e., when the NCO content reached is that corresponding theoretically to complete conversion of isocyanate groups and mercapto groups, the thioallophanatization may be started, for example, without addition of catalyst, by heating of the reaction mixture to a temperature of 120 to 200° C. However, for acceleration of the thioallophanatization reaction, preference is given to using suitable catalysts of the abovementioned kind where, depending on the kind and amount of catalyst used, temperatures in the range of 60 to 140° C., preferably 70 to 120° C., are sufficient to carry out the reaction.

In another possible embodiment of the process for preparing the silane group-containing thioallophanates, the catalyst for optional accompanying use is admixed either to the diisocyanate component a) and/or to the silane component b) even before the start of the actual reaction. In this case the thiourethane groups formed as intermediates undergo spontaneous further reaction to give the desired thioallophanate structure. In this kind of one-stage reaction regime, the starting diisocyanates a), optionally containing the catalyst, are introduced, optionally under inert gas—such as nitrogen, for example—and optionally in the presence of a suitable solvent of the stated type, in general at temperatures optimum for the thioallophanatization, in the range from 60 to 140° C., preferably 70 to 120° C., and are reacted with the silane component b), optionally containing the catalyst.

An alternative option is to add the catalyst to the reaction mixture at any desired point in time during the thiourethanization reaction. In the case of this embodiment of the process for preparing the silane group-containing thioallophanates, the temperature set for the pure thiourethanization reaction, which proceeds before the addition of catalyst, is generally in the range from 30 to 120° C., preferably from 50 to 100° C. Following addition of a suitable catalyst, finally, the thioallophanatization reaction is carried out at temperatures of 60 to 140° C., preferably of 70 to 120° C.

In the case of the preparation of the silane group-containing thioallophanates, the course of the reaction may be monitored by, for example, titrimetric determination of the NCO content. When the target NCO content has been reached, preferably when the degree of thioallophanatization (i.e., the percentage fraction, as computable from the NCO content, of the thiourethane groups which have formed as intermediates from the mercapto groups of component b) and have undergone reaction to form thioallophanate groups) of the reaction mixture is at least 70%, particularly preferably at least 90%, and very particularly preferably after complete thioallophanatization, the reaction is discontinued. In the case of purely thermal reaction regime this may be effected by cooling the reaction mixture to room temperature for example. In the case of the preferred accompanying use of a thioallophanatization catalyst of the type stated, however, the reaction is generally stopped by addition of suitable catalyst poisons, examples being acyl chlorides, such as benzoyl chloride or isophthaloyl dichloride.

The reaction mixture is preferably then freed from volatile constituents (excess monomeric diisocyanates, solvents optionally used, and, when no catalyst poison is being used, any active catalyst) by thin-film distillation under a high vacuum, as for example at a pressure below 1.0 mbar, preferably below 0.5 mbar, particularly preferably below 0.2 mbar, under very gentle conditions, as for example at a temperature of 100 to 200° C., preferably of 120 to 180° C.

The distillates obtained, which besides the unconverted monomeric starting diisocyanates, contain any solvents used, where no catalyst poison is used, any active catalyst, can be used readily for renewed oligomerization.

In another embodiment of the process for preparing the silane group-containing thioallophanates, the stated volatile constituents are removed from the oligomerization product by extraction with suitable solvents that are inert with respect to isocyanate groups, examples being aliphatic or cycloaliphatic hydrocarbons such as pentane, hexane, heptane, cyclopentane or cyclohexane.

Irrespective of the type of working up, the resulting products are clear, virtually colorless thioallophanate polyisocyanates, with color numbers generally of below 120 APHA, preferably of below 80 APHA, particularly preferably of below 60 APHA, and with an NCO content of 2.0% to 18.0% by weight, preferably 7.0% to 17.0% by weight, particularly preferably 10.0% to 16.0% by weight. The average NCO functionality, depending on the degree of conversion and the thioallophanatization catalyst used, is generally from 1.8 to 3.0, preferably from 1.8 to 2.5, particularly preferably from 1.9 to 2.1.

Besides the thioallophanate polyisocyanates, the polyisocyanate component (A) may optionally further contain polyisocyanates having aliphatically, cycloaliphatically, araliphatically and/or aromatically bonded isocyanate groups, which may optionally also already have silane groups. These further polyisocyanates are, in particular, the known coatings polyisocyanates with uretdione, isocyanurate, iminooxadiazinedione, urethane, allophanate, biuret and/or oxadiazinetrione structure, as described by way of example in Laas et al., J. Prakt. Chem. 336, 1994, 185-200, in DE-A1 670 666, DE A3 700 209, DE-A3 900 053, EP-A0 330 966, EP-A0 336 205, EP-A0 339 396 and EP-A0 798 299, and also reaction products of such polyisocyanates with compounds that contain silane groups and are reactive towards isocyanate groups, as described for example in EP-A1 273 640, WO 2014/086530 or WO 2009/156148.

Preferred further polyisocyanates which may be present optionally in the polyisocyanate component (A) in addition to the silane group-containing thioallophanates are those of the type stated having exclusively aliphatically and/or cycloaliphatically bonded isocyanate groups, more particularly those based on PDI, HDI and/or IPDI.

If used at all, in the coating compositions according to the invention, these further polyisocyanates are used in the polyisocyanate component (A) in amounts of up to 70% by weight, preferably up to 60% by weight, particularly preferably up to 50% by weight, based on the total amount of the polyisocyanate component (A) consisting of at least one silane group-containing thioallophanate and optionally of further polyisocyanates.

In the blends which are present in the event of accompanying use of further polyisocyanates of the stated kind as polyisocyanate components (A), the very low viscosity of the silane group-containing thioallophanate polyisocyanates causes them to take on the role of a reactive diluent for the coatings polyisocyanates, which are generally of higher viscosity. Relative to the hitherto-known, prior-art silane-functional polyisocyanates, for comparable silane contents, such blends of silane group-containing thioallophanate polyisocyanates with further polyisocyanates exhibit the advantage of considerably higher isocyanate contents and isocyanate functionalities in conjunction with much lower viscosities.

The free isocyanate groups of the polyisocyanates of component (A) may also be used in blocked form. This is preferably the case when the coating compositions according to the invention are used as one-component systems. In principle, any blocking agent usable for blocking polyisocyanates and having a sufficiently low deblocking temperature can be used for the blocking. Those skilled in the art are highly familiar with such blocking agents. Examples of such blocking agents are described in EP 0 626 888 A1 and EP 0 692 007 A1. As blocking agents, preference is given to using at least one compound selected from the group consisting of alcohols, phenols, pyridinols, thiophenols, quinolinols, mercaptopyridines, quinolinols, amides, imides, imidazoles, imidazolines, lactams, oximes, pyrazoles, triazoles, malonic esters, acetoacetic esters, acetyl ketones and cyclopentanone 2-alkyl esters as blocking agents. Blocking is more preferably effected with a compound selected from the group consisting of mercaptopyridines, quinolinols, amides, imides, imidazoles, imidazolines, lactams, oximes, pyrazoles, triazoles, malonic esters, acetoacetic esters, acetyl ketones and cyclopentanone 2-alkyl esters.

### Component (B)

The coating compositions according to the invention contain at least one isocyanate-reactive compound (B). An “isocyanate-reactive compound” is a compound bearing at least one group that is reactive towards isocyanates. Mono- or polyhydric alcohols, amino alcohols, amines and thiols are suitable in principle as isocyanate-reactive compound B. The aforementioned compounds preferably have an average functionality per molecule of at least 2 isocyanate-reactive groups.

Suitable isocyanate-reactive compounds (B) are for example the customary at least difunctional polyhydroxyl compounds known from polyurethane chemistry, such as for example polyester polyols, polyether polyols, polycarbonate polyols and/or polyacrylate polyols, or any desired blends of such polyols.

Suitable polyester polyols (B) are for example those having an average molecular weight, calculable from functionality and hydroxyl number, of 200 to 3000, preferably of 250 to 2500, having a hydroxyl group content of 1% to 21% by weight, preferably 2% to 18% by weight, of the kind preparable in a manner known per se by reaction of polyhydric alcohols with substoichiometric amounts of polybasic carboxylic acids, corresponding carboxylic anhydrides, corresponding polycarboxylic esters of lower alcohols, or lactones.

Polyhydric alcohols suitable for preparing these polyester polyols are, in particular, those of the molecular weight range 62 to 400, such as, for example, ethane-1,2-diol, propane-1,2- and -1,3-diol, the isomeric butanediols, pentanediols, hexanediols, heptanediols and octanediols, cyclohexane-1,2- and -1,4-diol, cyclohexane-1,4-dimethanol, 4,4′-(1-methylethylidene)biscyclohexanol, propane-1,2,3-triol, 1,1,1-trimethylolethane, hexane-1,2,6-triol, 1,1,1-trimethylolpropane, 2,2-bis(hydroxymethyl)propane-1,3-diol or 1,3,5-tris(2-hydroxyethyl) isocyanurate.

The acids or acid derivatives used for preparing the polyester polyols (B) may be aliphatic, cycloaliphatic and/or heteroaromatic in nature and may optionally be substituted, for example by halogen atoms, and/or unsaturated. Examples of suitable acids are, for example, polybasic carboxylic acids of the molecular weight range 118 to 300 or derivatives thereof such as, for example, succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bisglycol terephthalate.

For preparing the polyester polyols (B), it is also possible to use any desired mixtures of these exemplified starting compounds.

Suitable polyester polyols (B) are also those of the kind preparable in a known manner from lactones and simple polyhydric alcohols, such as those exemplified above, for example, as starter molecules, with ring opening. Examples of suitable lactones for preparing these polyester polyols are β-propiolactone, γ-butyrolactone, γ- and δ-valerolactone, ε-caprolactone, 3,5,5- and 3,3,5-trimethylcaprolactone or any desired mixtures of such lactones.

The preparation of these lactone polyesters is generally effected in the presence of catalysts, for example Lewis or Brønsted acids, organotin or organotitanium compounds, at temperatures of 20 to 200° C., preferably 50 to 160° C.

Suitable polyether polyols (B) are for example those having an average molecular weight, calculable from functionality and hydroxyl number, of 200 to 6000, preferably 250 to 4000, having a hydroxyl group content of 0.6% to 34% by weight, preferably 1% to 27% by weight, as obtainable in a manner known per se by alkoxylation of suitable starter molecules. To prepare these polyether polyols it is possible to use as starter molecules any desired polyhydric alcohols, examples being those from the molecular weight range of 62 to 400, such as described above with regard to the preparation of polyester polyols.

Alkylene oxides suitable for the alkoxylation reaction are in particular ethylene oxide and propylene oxide, which may be used in the alkoxylation reaction in any order or else in a mixture.

Suitable polyacrylate polyols (B) are, for example, those with an average molecular weight, calculable from functionality and hydroxyl number or determinable by gel permeation chromatography (GPC), of 800 to 50 000, preferably of 1000 to 20 000, having a hydroxyl group content of 0.1% to 12% by weight, preferably 1 to 10, as preparable in a manner known per se by copolymerization of olefinically unsaturated monomers containing hydroxyl groups with hydroxyl-group-free olefinic monomers.

Examples of suitable monomers for the preparation of the polyacrylate polyols (B) are vinyl and vinylidene monomers such as, for example, styrene, α-methylstyrene, o- and p-chlorostyrene, o-, m- or p-methylstyrene, p-tert-butylstyrene, acrylic acid, acrylonitrile, methacrylonitrile, acrylic and methacrylic esters of alcohols having up to 18 carbon atoms, such as methyl acrylate, ethyl acrylate, n-propyl acrylate, isopropyl acrylate, n-butyl acrylate, isobutyl acrylate, tert-butyl acrylate, amyl acrylate, hexyl acrylate, 2-ethylhexyl acrylate, isooctyl acrylate, 3,3,5-trimethylhexyl acrylate, stearyl acrylate, lauryl acrylate, cyclopentyl acrylate, cyclohexyl acrylate, 4-tert-butylcyclohexyl acrylate, isobornyl acrylate, methyl methacrylate, ethyl methacrylate, n-propyl methacrylate, isopropyl methacrylate, butyl methacrylate, isobutyl methacrylate, tert-butyl methacrylate, amyl methacrylate, hexyl methacrylate, 2-ethylhexyl methacrylate, isooctyl methacrylate, 3,3,5-trimethylhexyl methacrylate, stearyl methacrylate, lauryl methacrylate, cyclopentyl methacrylate, cyclohexyl methacrylate, 4-tert-butylcyclohexyl methacrylate, norbornyl methacrylate or isobornyl methacrylate, diesters of fumaric acid, itaconic acid or maleic acid with alcohols having 4 to 8 carbon atoms, acrylamide, methacrylamide, vinyl esters of alkanemonocarboxylic acids having 2 to 5 carbon atoms, such as vinyl acetate or vinyl propionate, hydroxyalkyl esters of acrylic acid or methacrylic acid having 2 to 5 carbon atoms in the hydroxyalkyl radical, such as 2-hydroxyethyl, 2-hydroxypropyl, 3-hydroxypropyl, 3-hydroxybutyl, 4-hydroxybutyl or trimethylolpropane monoacrylate or monomethacrylate or pentaerythritol monoacrylate or monomethacrylate, and also any desired mixtures of such exemplified monomers.

Preferred hydroxyl group-containing compounds (B) are polyester polyols, polycarbonate polyols and/or polyacrylate polyols of the type stated. Particularly preferred hydroxyl group-containing compounds (B) are polyacrylate polyols of the type stated, which may optionally be used in a mixture with polyester polyols and/or polycarbonate polyols of the type stated. Very particularly preferably, hydroxyl group-containing compounds used are exclusively polyacrylate polyols of the type stated.

As stated above, further suitable isocyanate-reactive compounds (B) used may be amino-functional compounds.

Preferred amines are organic, at least difunctional polyamines preferably selected from the group consisting of 1,2-ethylenediamine, 1,2- and 1,3-diaminopropane, 1,4-diaminobutane, 1,6-diaminohexane, isophoronediamine, the isomer mixture of 2,2,4- and 2,4,4-trimethylhexamethylenediamine, 2-methylpentamethylenediamine, diethylenetriamine, 4,4-diaminodicyclohexylmethane, hydrazine hydrate, dimethylethylenediamine, polyethers modified with amino end groups and compounds of formula (VI).

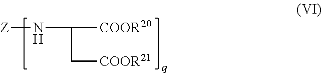

Here,
Z is a q-valent radical that is inert with respect to isocyanate groups, as obtained by removing the primary amino groups from an organic amine of molecular weight range 60 to 6000 having n primary aliphatically and/or cycloaliphatically bonded amino groups, which optionally contains one or more heteroatoms and/or further functional groups reactive towards isocyanate groups and/or inert at temperatures up to 100° C.,
R¹ and R²¹ are identical or different organic radicals having 1 to 18 carbon atoms and
q is an integer ≥1.

Likewise preferred are amines containing at least one amino group and at least one hydroxyl group (amino alcohols). Such compounds are preferably selected from the group consisting of diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol and neopentanolamine.

Of course, it is also possible to use mixtures of the above-described hydroxyl group- and amino group-bearing compounds as component B.

### Component (C)

The coating compositions according to the invention contain at least one alkoxysilyl-functional siloxane (Ci) and/or at least one hydroxyl group-containing siloxane (Cii).

Siloxanes are known to those skilled in the art. What are concerned here are components that are derived from pure silanes (i.e. binary compounds composed of Si and H) (derivatives of pure silanes) and are of general formula R₁Si—[O—SiR₂]ₙ—O—SiR₃, where R may be hydrogen atoms or alkyl groups. In siloxanes, the silicon atoms are therefore linked to their neighboring silicon atom via exactly one oxygen atom; they contain at least one Si—O—Si bond. If at least one of the hydrogen atoms is replaced by an organic radical such as for example an alkyl group, these are also referred to as organosiloxanes. Oligomeric or polymeric organosiloxanes (siloxanes where R H) have long Si—O main chains and are in turn referred to as silicones.

If the previously described organic radical of the organosiloxane additionally contains at least one hydroxyl group, thus at least one hydrogen radical has been substituted by a hydroxyl group in the organic radical, this is referred to as a hydroxyl group-containing siloxane (component Cii) in the context of the present invention.

If the previously described organic radical of the organosiloxane additionally contains at least one alkoxysilyl group, thus at least one hydrogen radical has been substituted by an alkoxysilyl group in the organic radical, as a result of which a hydrogen of the derivative derived from the pure siloxane is thus at least partly substituted by an organic radical which itself in turn contains an alkoxysilyl-functional group, this is referred to as an alkoxysilyl-functional siloxane (component Ci) in the context of the present invention.

An alkoxysilyl-functional radical is a functional group deriving from an alkoxysilane, a component derived from a pure silane and containing an Si—OR group. Thus, at least one hydrogen atom of a pure silane is substituted by an alkoxy group —OR, i.e. an alkyl group bonded to the the silicon via oxygen. Examples include mono-, di- or trimethoxy- or -ethoxysilane.

Accordingly, the alkoxysilyl-functional siloxanes (Ci) to be used according to the invention are derivatives of siloxane in which at least one hydrogen atom has been substituted by an organic radical in which in turn at least one hydrogen radical has been replaced by an alkoxysilyl group. The alkoxysilyl group is accordingly always to be understood as meaning a functional group of an alkyl group which is itself attached to the siloxane skeleton. The alkoxysilyl group is therefore always connected to the Si—O—Si skeleton via a divalent organic radical R, for example an alkylene, and never bonds directly to the siloxane base skeleton of Si—O—Si units.

Preferred alkoxysilyl-functional siloxanes (Ci) can be described by the following general formula (II)

R⁴—SiR⁵₂-Aₓ-B_{y}—O—SiR⁶₂-R⁷ (II),
in which A is an —[O—SiR⁸₂]— group and B is an —[O—SiR⁹R¹⁰]— group,
R⁵, R⁶, R⁸ and R⁹ independently of one another are linear or branched alkyl groups having 1 to 4 carbon atoms,
R⁴, R⁷ and R¹⁰ independently of one another are an -L-R¹¹ group, in which
L=a linear or branched 2-valent alkyl group and
R¹¹═H or —Si(R¹²)_{z}(OR¹³)_{3-z} where R¹², R¹³=a linear or branched alkyl group having 1 to 4 carbon atoms and z=0, 1 or 2, preferably z=0,
with the proviso that at least one of the radicals R⁴ or R⁷ and/or at least one group B includes a group R¹═—Si(R¹²)_{z}(OR¹³)_{3-z},
x is independently an integer from 1-20 and
y is independently an integer from 0-10,
wherein preferably x+y≤20,

The siloxane (Ci) thus in any case contains at least one group —Si(R¹²)_{z}(OR¹¹)_{3-z}.

If y>0, the polysiloxane chain besides units A also contains units B. If on the other hand y=0, only units A are present. It is preferable for only units A to be present (y=0). It is further preferable for y=0 and x to be a number from 6 to 14.

The alkoxysilyl-functional siloxanes (Ci) may be linear or branched depending on which radicals R⁴, R⁷ and/or R¹⁰ contain an alkoxysilyl group. If alkoxysilyl groups in the form of the radical R¹¹═—Si(R¹²)_{z}(OR¹³)_{3-z} where R¹², R¹³=a linear or branched alkyl group having 1-4 carbon atoms and z=0, 1 or 2, preferably z=0, are arranged only in the terminal position in the radicals R⁴ and R⁷, the alkoxysilyl-functional siloxane is linear. However, if alkoxysilyl groups are also present in the radical R¹⁰, the siloxane is branched. The siloxane is preferably linear.

The radicals R⁴, R⁷ and R¹⁰ are identical or different radicals, where at least one of the radicals is always an -L-R¹¹ group in which R¹¹ is an alkoxysilyl group. It is very particularly preferable for at least one of these radicals R⁴, R⁷ and R¹⁰ to include an -L-R¹¹ group in which L is an ethylene group and R¹¹ is a trialkoxysilane group. It is very particularly preferable for L to be an ethylene group and R¹¹ to be a trimethoxy or triethoxysilane group. It is very particularly preferable again for y=0 and both terminal groups R⁴ and R⁷ to be an -L-R¹¹ group in which L is an ethylene group and R¹¹ is a trimethoxy or triethoxysilane group. In a further very particularly preferred embodiment, y>0, R¹⁰ is an -L-R¹¹ group, in which L is an ethylene group and R¹¹ is a trialkoxysilane group, and R⁴ and R⁷ are an -L-R¹¹ group in which R¹¹ is a hydrogen atom.

Particularly preferably, the radicals R⁵, R⁶, R⁸, R⁹, R¹² and R¹³ are identical or different alkyl radicals, very particularly preferably these radicals R⁵, R⁶, R⁸, R⁹, R¹² and R¹³ are linear alkyl groups having one to four carbon atoms, and very particularly preferably again the radicals R⁵, R⁶, R⁸, R⁹, R¹² and R¹³ are methyl and/or ethyl radicals, in particular methyl radicals.

Component (Ci) contains at least one alkoxysilyl-functional siloxane. Alkoxysilyl-functional siloxanes having the alkoxysilyl function in the side chain may accordingly be present alongside those in which the alkoxysilyl function(s) are present in the terminal position on the siloxane chain.

Particularly preferred alkoxysilyl-functional siloxanes (Ci) are commercially available from Shin Etsu.

Preferred hydroxyl group-containing siloxanes (Cii) can be described by the following general formula (III):

R¹⁴—SiR¹⁵₂—(O—SiR¹⁶₂)_{w}—O—SiR¹⁷₂-R¹⁸ (III),
in which
R¹⁵, R¹⁶ and R¹⁷ independently of one another are linear or branched alkyl groups having 1 to 4 carbon atoms,
R¹⁴ and R¹⁸ independently of one another are an -L′-R¹⁹ group, in which
L′=a linear or branched 2-valent alkyl group and R¹⁹═H or OH, with the proviso that at least one of the radicals R¹⁴ or R¹⁸ corresponds to a radical -L′-OH,
w is an integer from 1-20.

Particularly preferably, the radicals R¹⁵, R¹⁶ and R¹⁷ are identical or different alkyl radicals, very particularly preferably these radicals R¹⁵, R¹⁶ and R¹⁷ are linear alkyl groups having one to four carbon atoms, and very particularly preferably again the radicals R¹⁵, R¹⁶ and R¹⁷ are methyl and/or ethyl radicals, in particular methyl radicals.

R¹⁴ and R¹⁸ independently of one another are an -L′-R¹⁹ group. I.e., R¹⁴ and R¹⁸ may be identical or different radicals -L′-R¹⁹. If they are different radicals, then both radicals R¹⁹ and/or both radicals L′ may be different, with the proviso that at least one of the radicals R¹⁴ or R¹⁸ is an -L′-OH radical, i.e. at least in one of the two radicals R¹⁹ is an OH group.

Particularly preferably, both radicals R¹⁴ and R¹⁸ are the radical -L′-OH. Very particularly preferably, both radicals R¹⁴ and R¹⁸ are the radical -L‘—OH and L’ in both radicals R¹⁴ and R¹⁸ is identical.

Component (Cii) contains at least one hydroxyl group-containing siloxane. Accordingly, mixtures of the above-described hydroxyl group-containing siloxanes may be present as component (Cii).

Particularly preferred hydroxyl group-containing siloxanes (Cii) are commercially available from Shin Etsu.

Of course, it is also possible for siloxanes of component Ci and Cii to be present in a mixture with one another.

The coating compositions according to the invention preferably contain from 0.001% to 5% by weight, preferably from 0.005% to 3% by weight and particularly preferably from 0.01% to 2% by weight, of component C, wherein the reported % by weight are based in each case on the total amount of polyisocyanate component (A), isocyanate-reactive component (B) and siloxane component (C).

### Component (D)

The coating compositions according to the invention further contain at least one catalyst (D) for crosslinking silane groups. These are any compounds which are capable of accelerating the hydrolysis and condensation of alkoxysilane groups or, preferably, the thermally induced silane condensation.

Examples of suitable catalysts (D) are acids, such as organic carboxylic acids, sulfuric acid, p-toluenesulfonic acid, trifluoromethanesulfonic acid, dodecylbenzenesulfonic acid, acetic acid, trifluoroacetic acid, phosphoric monoesters and phosphoric diesters, such as dibutyl phosphate, 2-ethylhexyl phosphate, phenyl phosphate and bis(2-ethylhexyl) phosphate, and also phosphonic diesters and diphosphonic diesters, as described in WO 2007/033786, for example.

Likewise suitable as catalysts (D) are also bases, such as the N-substituted amidines 1,5-diazabicyclo[4.3.0]non-5-ene (DBN) and 1,5-diazabicyclo[5.4.0]undec-7-ene (DBU), or else metal salts and metal chelates, such as tetraisopropyl titanate, tetrabutyl titanate, titanium(IV) acetylacetonate, aluminum tri-sec-butoxide, aluminum acetylacetonate, aluminum triflate, tin triflate or zirconium ethylacetoacetate, as described in WO 2006/042658, for example.

Suitable catalysts (D) are also phosphoric esters and phosphonic esters of the type stated above that are present in a form blocked with amines, preferably with tertiary amines. Particularly preferred catalysts of this type are those which release the acidic phosphoric and phosphonic esters again in the temperature range of the curing of automotive topcoats and clearcoats, as for example in the range from 100 to 150° C., with elimination of the blocking amine, said esters representing the actually active catalysts. Suitable amine-blocked phosphoric acid catalysts (D) are described in WO 2008/074489 and WO 2009/077180, for example.

Likewise suitable catalysts (D) are organic sulfonic acids of the type stated above which are used in blocked form, for example in amine-neutralized form, or as adduct with epoxides, as described in DE 2 356 768 B1, and which release the catalytically active sulfonic acids again above 100° C.

Further catalysts (D) suitable for crosslinking of silane groups also include tetraalkylammonium carboxylates, such as, for example, tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and/or tetrabutylammonium benzoate.

Catalysts (D) suitable for the crosslinking of silane groups are also quaternary ammonium and phosphonium polyfluorides, as known as trimerization catalysts for isocyanate groups from EP-A0 798 299, EP-A0 896 009 and EP-A0 962 455, for example.

Lastly, suitable catalysts (D) are also zinc-amidine complexes, which are preparable by the process of WO 2014/016019 by reaction of one or more zinc(II) biscarboxylates with amidines.

Preferred catalysts (D) for the crosslinking of silane groups are acidic phosphoric esters, phosphonic esters and sulfonic acids of the stated type, which may optionally be present in amine-blocked form, and also tetraalkylammonium carboxylates of the stated type. Particularly preferred catalysts (D) are amine-blocked phosphoric esters and sulfonic acids, and also the stated tetraalkylammonium carboxylates. Very particularly preferred catalysts (D) are amine-blocked phenyl phosphate and bis(2-ethylhexyl) phosphate, tetraethylammonium benzoate and tetrabutylammonium benzoate.

Besides the catalysts (D) stated by way of example above for silane crosslinking, the coating compositions according to the invention may optionally further also contain urethanization catalysts which are customary in isocyanate chemistry and which accelerate the reaction of the isocyanate groups in component (A) with the hydroxyl groups in component (B), examples of such catalysts including tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, zinc chloride, zinc 2-ethylcaproate, tin(II) octanoate, tin(II) ethylcaproate, dibutyltin(IV) dilaurate, zirconium(IV) isopropoxide, zirconium(IV) n-butoxide, zirconium(IV) 2-ethylhexanoate, zirconyl octanoate, bismuth(III) 2-ethylhexanoate, bismuth(III) octoate or molybdenum glycolate.

The catalysts (D) are used in the coating compositions according to the invention as individual substances or in the form of any desired mixtures with one another in amounts of 0.005% by weight up to 5% by weight, preferably of 0.005% by weight up to 2% by weight, particularly preferably of 0.005% by weight up to 1% by weight, calculated as the sum total of all catalysts (D) used, and based on the total amount of polyisocyanate component (A), isocyanate-reactive component (B) and siloxane component (C).

### Component (E)

The coating compositions according to the invention may optionally comprise further auxiliaries and additives (E). These are, in particular, the auxiliaries and additives known to the skilled person from coatings technology, such as, for example, solvents, UV stabilizers, antioxidants, water scavengers, leveling agents, rheological additives, slip additives, defoamers, fillers and/or pigments.

In order to reduce the processing viscosity, the coating compositions according to the invention may be diluted with customary organic solvents (E₁), for example. Solvents suitable for this purpose are, for example, the coatings solvents already described above as solvents for optional accompanying use in the preparation of the silane group-containing thioallophanates, these solvents behaving chemically inertly with respect to the reactive groups of the coating composition constituents, and having a water content of not more than 1.0% by weight, particularly preferably not more than 0.5% by weight, based on solvent used.

Suitable UV stabilizers (E₂) may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; triazine derivatives, for example 2-[4-[(2-hydroxy-3-dodecyloxypropyl)oxy]-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4 butoxybenzylidenemalonate. These preferred UV stabilizers may be used either individually or in any desired combinations with one another.

Optionally, one or more of the UV stabilizers (E₂) mentioned by way of example are added to the coating composition according to the invention, preferably in amounts of 0.001% to 3.0% by weight, particularly preferably 0.01% to 2% by weight, calculated as total amount of UV stabilizers used, based on the total amount of polyisocyanate component (A), isocyanate-reactive component (B), component (E) and siloxane component (C).

Suitable antioxidants (E₃) are preferably sterically hindered phenols, which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used as required either individually or in any desired combinations with one another.

These antioxidants (E₃) are preferably used in amounts of 0.01% to 3.0% by weight, particularly preferably 0.02% to 2.0% by weight, calculated as the total amount of antioxidants used based on the total amount of polyisocyanate component (A), isocyanate-reactive component (B) and siloxane component (C).

In order to prevent premature crosslinking of the silane groups in the coating compositions according to the invention, it may be advantageous to add water scavengers (E₄), examples being orthoformic esters, such as triethyl orthoformate, or vinylsilanes, such as vinyltrimethoxysilane. These water scavengers are used, if at all, in amounts of 0.01% by weight to 5% by weight, preferably of 0.01% by weight to 2% by weight, based on the total amount of polyisocyanate component (A), isocyanate-reactive component (B) and siloxane component (C).

In order to improve the substrate wetting, the coating compositions according to the invention may optionally contain suitable leveling agents (E₅), examples being organically modified siloxanes, such as polyether-modified siloxanes, polyacrylates and/or fluorosurfactants. These leveling agents are used, if at all, in amounts of 0.01% by weight to 3% by weight, preferably of 0.01% by weight to 2% by weight, particularly preferably of 0.05% to 1.5% by weight, based on the total amount of polyisocyanate component (A), isocyanate-reactive component (B) and siloxane component (C).

The coating compositions according to the invention may optionally also contain, as further crosslinker components (E₆), minor amounts of melamines. Suitable melamines include monomeric melamine, polymeric melamine-formaldehyde resin, or a combination thereof. The monomeric melamines include melamines with a low molecular weight which contain on average three or more methylol groups, etherified with a monohydric C1 to C5 alcohol, such as methanol, n-butanol or isobutanol, per triazine ring, and which have a mean degree of condensation of up to about 2 and preferably in the range from about 1.1 to about 1.8, and have a fraction of monocyclic species of not less than about 50% by weight. In contrast to this, the polymeric melamines have a mean degree of condensation of more than about 1.9. Some such suitable monomeric melamines include alkylated melamines, such as methylated, butylated, isobutylated melamines, and mixtures thereof. Many of these suitable monomeric melamines are supplied commercially. For example, Cytec Industries Inc., West Patterson, New Jersey, supply Cymel 301 (degree of polymerization of 1.5, 95% methyl and 5% methylol), Cymel 350 (degree of polymerization of 1.6, 84% methyl and 16% methylol), 303, 325, 327, 370 and XW3106, which are all monomeric melamines. Suitable polymeric melamines include melamine with a high amino fraction (partly alkylated, —N, —H), known in the form of Resimene BMP5503 (molecular weight 690, polydispersity of 1.98, 56% butyl, 44% amino), which is obtained from Solutia Inc., St. Louis, Missouri, or Cymel1158, provided by Cytec Industries Inc., West Patterson, New Jersey. Cytec Industries Inc. also supply Cymel 1130 with 80 percent solids (degree of polymerization of 2.5), Cymel 1133 (48% methyl, 4% methylol and 48% butyl), both of these being polymeric melamines.

The rheological additives, slip additives, defoamers, fillers and/or pigments which are likewise optionally present in the coating compositions according to the invention as further auxiliaries and additives (E) are known to those skilled in the art and are used, if at all, in amounts customary in coatings technology. A comprehensive overview of such suitable auxiliaries and additives may be found for example in Bodo Müller, “Additive kompakt”, Vincentz Network GmbH & Co KG (2009).

### Preparation of the Coating Compositions and Use

If the coating composition is a one-component (1K) coating composition, then isocyanate group-containing compounds (A) are selected the free isocyanate groups of which have been blocked with blocking agents. Blocking agents for use or for preferred use are described under the statements relating to component (A).

To prepare the 1K coating compositions, the components (A), (B), (C), (D) and optionally (E) are intimately mixed in any order in succession or together, preferably by means of suitable mixing units, until a homogeneous solution is present. Here, the polyisocyanate component (A) which contains at least one silane group-containing thioallophanate polyisocyanate, the isocyanate-reactive component (B) and, where present, the hydroxyl group-containing siloxane(s) (Cii), are typically used in amounts such that for each isocyanate group in the polyisocyanate component (A) there are 0.5 to 3.0, preferably 0.6 to 2.0, particularly preferably 0.8 to 1.6 isocyanate-reactive groups of components (B) and (Cii).

To prepare two-component (2K) coating compositions, which are preferred in accordance with the invention, 2 coating composition components are prepared separately, of which one contains the polyisocyanate component (A) and a second contains the isocyanate-reactive component (B). In addition, one of the two coating composition components contain the siloxane component (C) or both coating composition components contain proportions of the siloxane component (C), with preference being given to one coating composition component alone containing component (C). The coating composition component containing component (B) particularly preferably also contains component (C).

What has been stated above in relation to the 1K coating compositions applies with regard to the ratio of the polyisocyanate component (A) to the isocyanate-reactive compounds (B) and OH group-containing siloxanes (Cii).

The catalyst component (D) and the further auxiliaries and additives (E) for optional accompanying use may be added to the coating composition component containing the polyisocyanate component (A) and/or to the coating composition component containing the isocyanate-reactive component (B).

The 1K and 2K coating compositions thus obtained may be applied by methods known per se, as for example by spraying, spreading, dipping, flow-coating, or with the aid of rollers or knife coaters, in one or more layers.

Substrates contemplated here are any desired substrates, such as metal, wood, glass, stone, ceramic materials, concrete, rigid and flexible plastics, textiles, leather and paper, which prior to coating may optionally also be provided with customary known primers, primer-surfacer systems, basecoat systems and/or clearcoat systems.

The coating compositions according to the invention find use preferably in areas of application where a coating is subject to exacting requirements in terms of optical quality and resistance to mechanical scratching, and where the coatings are to additionally have high soiling resistance and be easy to clean. These include, in particular, decorative, protective and/or effect-imparting coatings and paint systems of high scratch resistance in the transport sector, for example on vehicle bodies, such as ships and aircraft, and on motor vehicle bodies, such as, for example, motorcycles, buses, trucks, passenger cars or rail vehicles, or on parts thereof. The coating compositions according to the invention are especially suitable for producing coatings and paint systems, particularly clearcoats, in automotive refinishing and also in automotive OEM finishing.

Here, the coating compositions according to the invention are preferably also used in the clearcoat or topcoat layer of multilayer constructions, particularly in the context of multistage coating methods, wherein first a pigmented basecoat layer and thereafter a layer of the coating composition according to the invention are applied to an optionally precoated substrate.

A further embodiment of the present invention relates to a method for coating surfaces, containing the steps of
a) applying the coating composition to a substrate; and
b) curing the coating composition.

The coating compositions according to the invention are processed preferably by spray application methods, such as, for example, compressed air spraying, airless spraying, high-speed rotation, electrostatic spray application (ESTA), optionally in conjunction with hot spray applications such as hot air spraying, for example. The individual constituents of the coating compositions according to the invention are preferably not mixed in these spray application activities until immediately prior to processing; mixing may take place advantageously in so-called two-component units.

The coating compositions according to the invention may be cured immediately following application or after a certain flash-off time has been observed. The flash-off time serves, for example, for the leveling and for the degassing of the coating layers, or for the evaporation of volatile constituents, such as solvents, for example. The required duration of the flash-off time may be controlled in a targeted way by means, for example, of application of elevated temperatures and/or by means of a reduced atmospheric humidity.

The ultimate curing of the applied coating compositions according to the invention is effected, finally, by customary and known methods, such as heating in a circulating-air oven, irradiation with IR lamps or near infrared (NIR radiation), preferably in a temperature range from 30 to 200° C., particularly preferably 40 to 190° C. and very particularly preferably 50 to 180° C., for a time of 1 min up to 12 h, particularly preferably 2 min up to 6 h and very particularly preferably 3 min up to 4 h.

The method is preferably employed for the coating of surfaces in the fields of application stated earlier on above.

The coatings produced in this way from the coating compositions according to the invention, these coatings preferably constituting clearcoats, are notable for high scratch resistance and solvent resistance, and also for good soiling resistances and (self)-cleaning properties.

In a further embodiment, the present invention relates to the use of the above-described coating compositions according to the invention for producing coatings and paint systems.

Said coatings and paint systems are preferably used for producing clearcoats.

Particularly preferred is the use of the coating compositions according to the invention for producing coatings and paint systems in automotive refinishing and in automotive OEM finishing.

A further embodiment of the present invention relates to substrates coated with one or more coating compositions according to the invention.

The substrate is preferably selected from the group consisting of metal, wood, wood-based materials, glass, stone, ceramic materials, mineral building materials, rigid and flexible plastics, textiles, leather and paper.

The examples which follow serve to illustrate the invention. They are not intended to restrict in any way the scope of protection of the claims.

### Examples

All percentages are based on weight, unless stated otherwise.

NCO contents were determined titrimetrically in accordance with DIN EN ISO 11909:2007-05.

All viscosity measurements were taken using a Physica MCR 51 rheometer from Anton Paar Germany GmbH (DE) to DIN EN ISO 3219:1994-10 at a shear rate of 250 s.

The flow time was determined in accordance with DIN EN ISO 2431:2012-03 using an ISO flow cup with a 5 mm nozzle.

To produce automotive clearcoats, the polyols described below were in each case mixed, by intensive stirring at room temperature to form a homogeneous mixture, with a commercial leveling additive (BYK 331; BYK-Chemie GmbH, Wesel, DE, use as 50% solution in MPA), the light stabilizers Tinuvin 292 and Tinuvin 384-2 (BASF SE, Ludwigshafen, DE, use of 1%/1.5% as supplied based on binder solids) and also, for all silane-containing formulations, Vestanat EP-CAT 11 B (tetraethylammonium benzoate, 50% solution in butanol, Evonik, Essen, Germany, use of 1% based on binder solids) as catalyst C) and also, depending on the formulation, the additives KF-6000/KR-410 (Shin-Etsu, Japan). The respective polyisocyanates were stirred into this coating base component and the solids content of the complete coating composition was adjusted with 1-methoxy-2-propyl acetate/solvent light naphtha (1:1) to a flow time of approximately 28 s in an ISO cup with 5 mm nozzle. In the case of examples 6, 7, 12 and 13, the additives KR-6000/KF-410 were not stirred into component B but instead into the polyisocyanate (component A) and left over night for equilibration prior to mixing with component B.

Table 1 shows the compositions of the individual formulations.

To determine the König pendulum damping (in accordance with DIN EN ISO 1522:2007), to test the solvent resistance, for the condensation water test and for the marker test, the coating compositions were each applied to glass plates using a gravity-fed cup gun and, after flashing off at room temperature for 10 minutes, cured at 140° C. within 30 minutes. All glass plates were stored for at least 48 h at room temperature prior to the testing.

To test the coatings for solvent resistance (surface solubility), small amounts of each of the solvents xylene (X), 1-methoxy-2-propyl acetate (MPA), ethyl acetate (EA) and acetone (A) were placed in test tubes and provided with a cotton-wool pad at the opening, thus forming a solvent-saturated atmosphere within the test tubes. The test tubes were subsequently brought with the cotton-wool pad onto the surface of the coating film applied to glass, where they remained for 5 minutes. After the solvent had been wiped off, the film was examined for destruction/softening/loss of adhesion and rated (0=no change, 5=film completely dissolved). The evaluations reported are those for the four solvents in the order in each case of X, MPA, EA and A in the form of four successive digits.

Resistance to condensation water was tested in accordance with DIN EN ISO 6270-2 CH:2018 for 240 hours.

To determine the easy-to-clean properties by the so-called marker test, a broad line was applied to the coating with a commercial Edding 3000 green permanent marker (Edding, Ahrensburg, Germany) which was wiped off as much as possible after 10 seconds with a dust-free cloth. The intensity of the residue was visually assessed (0=no visible residue, 5=complete line still present). The application characteristics were also evaluated (+=readily applicable, Z=marking contracts) The contact angles with water were measured both on glass and on the construction (see below). The measurements were taken with an OCA20 device from Data Physics. To this end, 10 droplets of in each case about 2 μL of distilled water were placed onto the coating surface and the contact angle formed was recorded after about 3 s. The mean was calculated from the 10 measured values. Droplet analysis and evaluation was performed using the SCA software from Data Physics.

The scratch resistance of the easy to clean properties was tested by contact angle measurements before and after scratching of the complete OEM multilayer construction on steel sheet.

To this end, the coating compositions were applied with a gravity-fed cup gun as clearcoats on cathodically dip coated metal sheets (dry layer thickness about 40 μm metal test sheets from Daimler, Germany), that had been coated beforehand with a commercial 1K OEM waterborne primer-surfacer (dry layer thickness about 35 μm) and a black 1K OEM waterborne basecoat (dry layer thickness about 15 μm). While the waterborne primer-surfacer was cured fully by baking at 165° C. for 20 minutes, the waterborne basecoat was merely subjected to preliminary drying at 80° C. for 10 minutes. Following the application of the clearcoats, the basecoat layer and the clearcoat layer were cured together at 140° C. over the course of 30 minutes. All metal sheets were stored for at least 48 h at room temperature prior to testing.

Wet scratching was carried out using an Amtec Kistler laboratory car wash in accordance with DIN EN ISO 20566:2016.

Table 2 shows a comparison of the results of the performance tests, each determined after a storage time of at least 48 h at 23° C.

### Preparation of the 1K OEM Waterborne Basecoat

| | | |
|---|---|---|
| I.) | Setaqua 6803 (Allnex Resins, Germany) as supplied | 36.94 |
| | Bayhydrol UA 2856 XP (Covestro Deutschland AG, Germany) as supplied | 15.20 |
| | Luwipal 072 (BASF SE, Germany) as supplied | 4.73 |
| | Distilled water | 20.65 |
| | Dimethylethanolamine, 10% in distilled H₂O (for a pH of 8-8.5) | 5.59 |
| | 2-Ethyl-1-hexanol | 2.84 |
| | BYK 347 (Byk-Gardner GmbH, Germany) as supplied | 0.18 |
| | BYK 345 (Byk-Gardner GmbH, Germany) as supplied | 0.18 |
| | BYK 011 (Byk-Gardner GmbH, Germany) as supplied | 1.49 |
| | Byketol AQ (Byk-Gardner GmbH, Germany) as supplied | 2.80 |
| | n-Butanol | 0.14 |
| | Rheovis AS 1130, as supplied | 1.18 |

disperse at about 5.2 m/s for 5 min

| | | |
|---|---|---|
| II.) | Pigment paste, black, consisting of: | 6.31 |
| | Setaqua B E 270 (Allnex Resins, Germany) as supplied | 10.40 |
| | distilled water | 41.60 |
| | Borchi Gen 0851 (Borchers GmbH, Germany) as supplied | 32.00 |
| | Colour Black FW 200 (Evonik Degussa GmbH, Germany) | 16.00 |

disperse at about 10.5 m/s for 30 min
add part II in portions to part I while stirring

| | |
|---|---|
| Total weight | 100.00 |
| Solids content at spray viscosity | About 21.8% |
| Flow time, DIN cup, 4 mm | About 30 s |
| pH | 8.0-8.5 |

### Preparation of the 1K OEM Waterborne Primer-Surfacer

| I.) | Mill base | |
|---|---|---|
| | Setaqua B E 270, 70% (Allnex Resins, Germany) as supplied | 4.28 |
| | Distilled water | 9.43 |
| | DMEA, 10% in water | 0.61 |
| | BYK 011 (Byk-Gardner GmbH, Germany) as supplied | 1.01 |
| | Surfynol 104 E (Evonik Resource Efficiency GmbH, Germany) as supplied | 0.55 |
| | Sachtleben R-FD-I (Sachtleben Pigment GmbH, Germany) | 10.98 |
| | Bayferrox 303T (Lanxess Deutschland GmbH, Germany) | 0.12 |
| | Blanc fixe micro (Sachtleben Pigment GmbH, Germany) | 11.05 |
| | Microtalc IT extra (Mondo Minerals, the Netherlands) | 2.70 |
| | Aerosil R 972 (Evonik Industries, Germany) | 0.38 |
| II.) | Setaqua BE 270, 70% as supplied (Allnex Resins GmbH, Germany) | 6.38 |
| | Maprenal MF 904, as supplied (Prefere Melamines GmbH, Germany) | 1.92 |
| | Maprenal MF 915, as supplied (Prefere Melamines GmbH, Germany) | 2.48 |
| | Butyl diglycol | 1.99 |
| | Tripropylene glycol | 1.99 |
| | BYK 346, as supplied (Byk-Gardner GmbH, Germany) | 0.50 |
| | Bayhytherm 3246, 46% as supplied (Covestro Deutschland AG, Germany) | 29.66 |
| | DMEA, 10% in water | 1.08 |
| | Distilled water | 12.89 |

| | |
|---|---|
| Total weight | 100.00 |
| Solids content at spray viscosity | About 48% |
| Flow time, ISO cup, 5 mm | About 40 s |

### Starting Compounds Used

### Desmodur Ultra N 3390 BA/SN:

Aliphatic polyisocyanurate polyisocyanate based on HDI (Covestro Deutschland AG, Leverkusen), 90% solution in n-butyl acetate/solvent naphtha 100 (1:1), NCO content: 19.6%, viscosity at 23° C.: 550 mPas.

### Desmodur Z 4470 MPA/X:

Aliphatic polyisocyanurate polyisocyanate based on IPDI (Covestro Deutschland AG, Leverkusen), 70% solution in 1-methyl-2-propyl acetate/xylene 100 (1:1), NCO content: 11.9%, viscosity at 23° C.: 1500 mPas.

### Silane-Functional Polyisocyanate P1:

672 g (4 mol) of hexamethylene diisocyanate (HDI) and 0.1 g of zinc(II) 2-ethyl-1-hexanoate were initially charged at a temperature of 80° C. under dry nitrogen and with stirring. Over a period of about 30 minutes, 196 g (1.0 mol) of mercaptopropyltrimethoxysilane were added dropwise, with the temperature of the mixture rising to up to 85° C. owing to the exothermic reaction that set in. The reaction mixture was stirred further at 85° C. until, after about 2 hours, the NCO content had dropped to 29.0%. The catalyst was deactivated by addition of 0.1 g of orthophosphoric acid and the unreacted monomeric HDI was removed in a thin-film evaporator at a temperature of 130° C. and a pressure of 0.1 mbar. This gave 486 g of a virtually colorless, clear polyisocyanate mixture, the characteristics and composition of which were as follows:
NCO content: 11.8%
Monomeric HDI: 0.06%
Viscosity (23° C.): 452 mPas
Thiourethane: 0.0 mol %
Thioallophanate: 99.0 mol %
Isocyanurate groups: 1.0 mol %
Si content (calculated): 6.1%
   Silane-functional polyisocyanate P2:

42.0 parts by weight of a commercial solvent-free polyisocyanurate polyisocyanate based on HDI (Desmodur N 3300, Covestro Deutschland AG, Leverkusen) with an NCO content of 21.8% and a viscosity at 23° C. of 3000 mPas were initially charged together with 36.0 parts by weight of n-butyl acetate at 25° C. and to this initial charge was added, within 120 min, a mixture of 2.0 parts by weight of N-[3-(trimethoxysilyl)propyl]butylamine and 20.0 parts by weight of bis[3-(trimethoxysilyl)propyl]amine. A polyisocyanate containing silane groups was obtained after a further stirring time of 30 min. The NCO content of the solution was 6.3%, the viscosity of the 64% solution was 90 mPas at 23° C.

### Setalux 91767 VX-60:

Sag control agent-modified polyacrylate polyol (Allnex Germany GmbH, Bitterfeld-Wolfen, DE), 60% solution in solvent naphtha/xylene (76/24), OH number (based on form as supplied): 90 mg KOH/g.

### Setalux D A 665 BA/X

Polyacrylate polyol (Allnex Germany GmbH, Bitterfeld-Wolfen, DE), 65% solution in butyl acetate/xylene (75:25), OH number: 150 mg KOH/g (based on form as supplied), viscosity at 23° C.: approx. 2400 mPas.

### KR-410:

Linear alkoxysilyl-functional siloxane (Shin-Etsu, Japan), as supplied.

### KF-6000:

Linear hydroxy-functional siloxane (Shin-Etsu, Japan), as supplied.

TABLE 1
Clearcoat formulations All figures in g unless stated otherwise

| | | | | | | | | | | | | | |
|---|---|---|---|---|---|---|---|---|---|---|---|---|---|
| | 1 | 2 | 3 | | | | | 8 | 9 | 10 | 11 | 12 | 13 |
| Example | (Comp.) | (Comp.) | (Comp.) | 4 | 5 | 6 | 7 | (Comp.) | (Comp.) | (Comp.) | (Comp.) | (Comp.) | (Comp.) |

Component B

| | | | | | | | | | | | | | |
|---|---|---|---|---|---|---|---|---|---|---|---|---|---|
| Setalux D A 665 BA/X | 145.65 | 145.65 | 112.94 | 112.94 | 112.94 | 112.94 | 112.94 | 78.29 | 78.29 | 80.88 | 80.88 | 102.04 | 103.27 |
| Setalux 91767 VX-60 | 39.45 | 39.45 | 30.59 | 30.59 | 30.59 | 30.59 | 30.59 | 21.20 | 21.20 | 21.91 | 21.91 | 27.63 | 27.97 |
| Byk 331, 10% in BA | 0.18 | 0.18 | 0.18 | 0.18 | 0.18 | 0.18 | 0.18 | 0.18 | 0.18 | 0.18 | 0.18 | 0.18 | 0.18 |
| Tinovin 292, 50% in | 1.80 | 1.80 | 1.80 | 1.80 | 1.80 | 1.80 | 1.80 | 1.80 | 1.80 | 1.80 | 1.80 | 1.80 | 1.80 |
| MPA | | | | | | | | | | | | | |
| Tinuvin 384-2, 50% in | 2.70 | 2.70 | 2.70 | 2.70 | 2.70 | 2.70 | 2.70 | 2.70 | 2.70 | 2.70 | 2.70 | 2.70 | 2.70 |
| MPA | | | | | | | | | | | | | |
| Methoxypropyl acetate | 19.05 | 19.05 | 19.05 | 19.05 | 19.05 | 19.05 | 19.05 | 19.05 | 19.05 | 19.05 | 19.05 | 19.05 | 19.05 |
| (MPA) | | | | | | | | | | | | | |
| Solvent light naphtha | 19.05 | 19.05 | 19.05 | 19.05 | 19.05 | 19.05 | 19.05 | 19.05 | 19.05 | 19.05 | 19.05 | 19.05 | 19.05 |
| Vestanal EP-CAT 11 B | 3.60 | 3.60 | 3.60 | 3.60 | 3.60 | 3.60 | 3.60 | 3.60 | 3.60 | 3.60 | 3.60 | 3.60 | 3.60 |
| KR-410 | 1.50 | | | 1.50 | | | | 1.50 | | 1.50 | | | |
| KF-6000 | | 1.50 | | | 1.50 | | | | 1.50 | | 1.50 | | |

Component A

| | | | | | | | | | | | | | |
|---|---|---|---|---|---|---|---|---|---|---|---|---|---|
| Desmodur ultra N 3390 | 68.51 | 68.51 | | | | | | | | | | | |
| BA/SN | | | | | | | | | | | | | |
| Polyisocyanate P1) | | | 88.23 | 88.23 | 88.23 | 88.23 | 88.23 | | | | | | |
| Polyisocyanate P2) | | | | | | | | 116.39 | 116.39 | 105.34 | 105.34 | 151.71 | 145.64 |
| Desmodor Z 4470 | | | | | | | | | | 4.65 | 4.65 | | 4.12 |
| MPA/X | | | | | | | | | | | | | |
| KR-410 | | | | | | 1.50 | | | | | | | |
| KF-6000 | | | | | | | 1.50 | | | | | 1.50 | 1.50 |
| Methoxypropyl acetate | 34.20 | 34.20 | 22.20 | 22.20 | 22.20 | 22.20 | 22.00 | | | 2.20 | 2.20 | 6.00 | 9.00 |
| (MPA) | | | | | | | | | | | | | |
| Solvent light naphtha | 34.20 | 34.20 | 22.20 | 22.20 | 22.20 | 22.20 | 22.20 | | | 2.20 | 2.20 | 6.00 | 9.00 |

Description

| | | | | | | | | | | | | | |
|---|---|---|---|---|---|---|---|---|---|---|---|---|---|
| Sum of parts by weight | 369.89 | 369.89 | 322.54 | 324.04 | 324.04 | 324.04 | 323.84 | 263.76 | 263.76 | 265.06 | 309.91 | 341.26 | 346.88 |
| NCO:OH | 1:1 | 1:1 | 1:1 | 1:1 | 1:1 | 1:1 | 1:1 | 1:1 | 1:1 | 1:1 | 1:1 | 1:1 | 1:1 |
| Solids content on | 49.2 | 49.2 | 56.6 | 56.1 | 56.1 | 56.3 | 56.4 | 53.1 | 53.1 | 52.2 | 46.1 | 54.1 | 53.2 |
| application [%] | | | | | | | | | | | | | |

TABLE 2
Test results

| | | | | | | | | | | | | | |
|---|---|---|---|---|---|---|---|---|---|---|---|---|---|
| | 1 | 2 | 3 | | | | | 8 | 9 | 10 | 11 | 12 | 13 |
| Example | (Comp.) | (Comp.) | (Comp.) | 4 | 5 | 6 | 7 | (Comp.) | (Comp.) | (Comp.) | (Comp.) | (Comp.) | (Comp.) |

Tests on glass

| | | | | | | | | | | | | | |
|---|---|---|---|---|---|---|---|---|---|---|---|---|---|
| Layer thickness | 40 μm | 47 μm | 40 μm | 41 μm | 37 μm | 48 μm | 40 μm | 34 μm | 36 μm | 44 μm | 43 μm | 45 μm | 41 μm |
| Pendulum hardness [s] | 24 | 19 | 182 | 186 | 175 | 178 | 124 | 203 | 198 | 200 | 196 | 191 | 191 |
| After condensation | 162 | 166 | 131 | 140 | 122 | 103 | 131 | 133 | 132 | 137 | 128 | 135 | 135 |
| water test | | | | | | | | | | | | | |
| Surface solubility | 0 0 0 0 | 1 1 2 3 | 0 0 0 0 | 0 0 0 1 | 1 1 1 1 | 0 0 0 0 | 0 0 0 1 | 0 0 0 0 | 0 0 0 0 | 0 0 0 0 | 0 0 0 0 | 0 0 0 0 | 0 0 0 0 |
| Marker test | 4 | 1 | 3 | 0-1 | 1 | 0 | 0 | 1 | 1 | 1 | 1-2 | 2 | 1 |
| After condensation | 1 | 1 | 3 | 1 | 0 | 0 | 1 | 0 | 0 | 0 | 0 | 0 | 0 |
| water test | | | | | | | | | | | | | |
| Marker test application | — | Z | — | Z | Z | Z | Z | Z | Z | Z | Z | Z | Z |
| characteristics | | | | | | | | | | | | | |
| After condensation | Z | Z | — | Z | Z | Z | Z | Z | Z | Z | Z | Z | Z |
| water test | | | | | | | | | | | | | |
| Contact angle (water) | 103.9 | 88.7 | 81.9 | 103.3 | 100.2 | 101.0 | 101.1 | 100.5 | 100.9 | 100.9 | 101.4 | 90.7 | 101.7 |

Tests on OEM complete construction

| | | | | | | | | | | | | | |
|---|---|---|---|---|---|---|---|---|---|---|---|---|---|
| Contact angle (water) | 102.9 | 104.1 | 82.4 | 102.2 | 103.6 | 97.7 | 101.9 | 99.9 | 101.5 | 102.5 | 102.1 | 89.9 | 100.9 |
| before scratching [°] | | | | | | | | | | | | | |
| Contact angle (water, | 101.5 | 101.7 | 79.3 | 101.0 | 102.1 | 104.2 | 98.0 | 90.3 | 88.6 | 101.2 | 92.4 | 80.8 | 93.1 |
| after scratching) [°] | | | | | | | | | | | | | |
| Difference after | 1.4 | 2.4 | 3.1 | 1.2 | 1.5 | −6.5 | 3.9 | 9.6 | 12.9 | 1.3 | 9.7 | 9.1 | 7.8 |
| scratching [°] | | | | | | | | | | | | | |

All coating materials cured to form hard, glossy coatings.

Compared to the comparative examples devoid of silane group-containing thioallophanate (polyisocyanate P1) and also comparative example 3 devoid of silane-functional additive, examples 4 to 7 according to the invention exhibit better easy-to-clean properties in the marker test and also a consistently high contact angle when applied to glass. While comparative examples 1 and 3 stand out in the marker test due to poor results, comparative example 2 exhibits poorer values in surface solubility and at the same time a lower contact angle when applied to glass.

Compared to comparative example 8, example 4 according to the invention, with alkoxysilyl-functional additive, exhibits a markedly higher contact angle when the clearcoat is applied to glass. The contact angle, measured on the construction, also remains stable after wet scratching in the case of example 4 according to the invention, with alkoxysilyl-functional additive, and example 5 according to the invention, with hydroxysilyl-functional additive, whereas the contact angle of comparative examples 8 and 9 falls markedly after wet scratching.

With the polyisocyanate P1) according to the invention in combination with a hydroxysilyl-functional additive, it is also possible to produce a coating (example 5) which even after wet scratching has a high contact angle of over 100°. In contrast to this, the contact angle fell markedly after wet scratching in the case of comparative examples 9 and 11 with hydroxysilyl-functional additive.

Moreover, it is also possible, with the polyisocyanate P1) according to the invention, to mix the hydroxysilyl-functional additive with the polyisocyanate component. This forms a coating (example 7) in which the contact angle decreases only to a minor extent after wet scratching, whereas the contact angle falls markedly after wet scratching in the case of comparative examples 12 and 13.

In summary, it can be stated that the coating compositions according to the invention can be used to obtain coatings that in terms of their solvent resistance are at least comparable to prior art coatings and in terms of their scratch resistance and easy-to-clean properties exhibit clear advantages compared to such coatings.

1. A nonaqueous coating composition containing or consisting of
A) at least one polyisocyanate component (A) which contains at least one silane group-containing thioallophanate of the general formula (I), 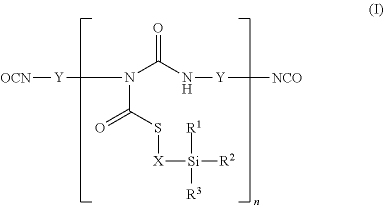
in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical having at least 2 carbon atoms,
Y is a linear or branched, aliphatic or cycloaliphatic, an araliphatic or aromatic radical having up to 18 carbon atoms and
n is an integer from 1 to 20,
B) at least one isocyanate-reactive compound (B), excluding compounds of component Cii),
C) i) at least one alkoxysilyl-functional siloxane (Ci) of formula (II)
R⁴—SiR⁵₂-Aₓ-B_{y}—O—SiR⁶₂-R⁷ (II),
in which A is an —[O—SiR⁸₂]— group and B is an —[O—SiR⁹R¹⁰]— group,
R⁵, R⁶, R⁸ and R⁹ independently of one another are linear or branched alkyl groups having 1 to 4 carbon atoms,
R⁴, R⁷ and R¹⁰ independently of one another are an -L-R¹¹ group, in which
L=a linear or branched 2-valent alkyl group and
R¹¹═H or —Si(R¹²)_{z}(OR¹)_{3-z} where R¹², R¹³=a linear or branched alkyl group having 1 to 4 carbon atoms and z=0, 1 or 2,
with the proviso that at least one of the radicals R⁴ or R⁷ and/or at least one group B includes a group R¹¹═—Si(R¹²)(OR¹³)_{3-z},
x is independently an integer from 1-20 and
y is independently an integer from 0-10,
and/or
ii) at least one hydroxyl group-containing siloxane (Cii) of formula (III)
R¹⁴—SiR¹₂—(O—SiR¹⁶₂)_{w}—O—SiR¹⁷₂-R¹⁸ (III),
in which
R¹⁵, R¹⁶ and R¹⁷ independently of one another are linear or branched alkyl groups having 1 to 4 carbon atoms,
R¹⁴ and R¹⁸ independently of one another are an -L′-R¹⁹ group, in which
L′=a linear or branched 2-valent alkyl group and R¹⁹═H or OH, with the proviso that at least one of the radicals R¹⁴ or R¹⁸ corresponds to a radical -L′-OH,
w is an integer from 1-20,
D) at least one catalyst for the crosslinking of silane groups (D), and
E) optionally further auxiliaries and additives (E).

2. The coating composition as claimed in claim 1, wherein the polyisocyanate component (A) contains at least one silane group-containing thioallophanate of the formula (I), in which
R¹, R² and R³ are each alkyl radicals having up to 6 carbon atoms and/or alkoxy radicals which contain up to 3 oxygen atoms, with the proviso that at least one of the radicals R¹, R² and R³ is such an alkoxy radical, and
X is a propylene radical (—CH₂—CH₂—CH₂—),
Y and n are as previously defined.

3. The coating composition as claimed in claim 1, wherein the polyisocyanate component (A) contains at least one silane group-containing thioallophanate of the formula (I), in which
R¹, R² and R³ are identical or different radicals and are each methyl, methoxy or ethoxy, with the proviso that at least one of the radicals R¹, R² and R³ is a methoxy or ethoxy radical,
X is a propylene radical (—CH₂—CH₂—CH₂—), and
Y is a linear or branched, aliphatic or cycloaliphatic radical having 5 to 13 carbon atoms, and
n is a previously defined.

4. The coating composition as claimed in claim 1, wherein the polyisocyanate component (A) contains at least one silane group-containing thioallophanate of the formula (I), in which
Y is an aliphatic and/or cycloaliphatic radical as obtained by removing the isocyanate groups from a diisocyanate selected from the series of 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane.

5. The coating composition as claimed in claim 1, wherein isocyanate-reactive binder component (B) contains at least one polyester polyol, polyether polyol, polycarbonate polyol, polyacrylate polyol, polyamine, amino alcohol and/or melamine resin.

6. The coating composition as claimed in claim 5, wherein the isocyanate-reactive binder component (B) contains at least one polyester polyol, polyether polyol, polycarbonate polyol and/or polyacrylate polyol.

7. The coating composition as claimed in claim 1, wherein component (C)
contains at least one alkoxysilyl-functional siloxane (Ci) of the formula (II), wherein R⁵, R⁶ and R⁸ independently of one another are methyl and/or ethyl, R⁴ and R⁷ independently of one another are a group -L-R¹¹, in which L=a linear or branched 2-valent alkyl group, and R¹¹═—Si(R¹²)_{z}(OR¹³)_{3-z} where R¹², R¹³=a linear or branched alkyl group having 1 to 4 carbon atoms and z=0, 1, or 2, and y=0,
and/or
contains at least one hydroxyl group-containing siloxane (Cii) of the formula (III), wherein R¹⁵, R¹⁶ and R¹⁷ independently of one another are methyl and/or ethyl, R¹⁴ and R¹⁸ independently of one another are a group -L′-R¹⁹, in which L=a linear or branched 2-valent alkyl group and R¹⁹═OH.

8. The coating composition as claimed in claim 1, wherein the catalyst component (D) contains at least one acidic phosphoric ester, phosphonic ester and/or a sulfonic acid, which may optionally be present in amine-blocked form, and/or at least one tetraalkylammonium carboxylate.

9. The coating composition as claimed in claim 1, wherein the individual components (A), (B) and optionally (Cii) are present in proportions such that for each isocyanate group of the polyisocyanate component (A) there are 0.5 to 3.0 isocyanate-reactive groups of components (B) and (Cii).

10. The coating composition as claimed in claim 1, wherein the coating composition contains from 0.001% to 5% by weight of component C, wherein the reported % by weight are based in each case on the total amount of polyisocyanate component (A), isocyanate-reactive component (B) and siloxane component (C).

11. A method for producing coatings or paint comprising providing the coating composition as claimed in claim 1.

12. The method as claimed in claim 11, wherein the coating composition is cured in a temperature range of 30 to 200° C. over a time of 1 min up to 12 h.

13. A substrate coated with a coating composition as claimed in claim 1.

14. The coating composition as claimed in claim 1, wherein the coating composition is a two-component coating composition and
the coating composition component that contains the polyisocyanate component (A) or the coating composition component that contains the isocyanate-reactive component (B) contains the siloxane component (C), or
the coating composition component that contains the polyisocyanate component (A) and the coating composition component that contains the isocyanate-reactive component (B) each contain a proportion of the siloxane component (C).

15. The coating composition as claimed in claim 1, wherein x+y≤20.

16. The method as claimed in claim 11, wherein the coatings or paints comprise clearcoats for substrates in automotive refinishing and automotive OEM finishing.
